(19) United States
(12) Patent Application Publication
(10) Pub. No.: US 2023/0109494 A1
(43) Pub. Date: Apr. 6, 2023

(54) METHODS AND DEVICES FOR BUILDING A TRAINING DATASET

(71) Applicant: Continental Automotive Technologies GmbH, Hannover (DE)

(72) Inventors: Ionut-Valentin Gheorghe, Singureni (RO); Christian Hellert, Aschaffenburg (DE); Antje Elisabeth Loyal, Frankfurt am Main (DE)

(73) Assignee: Continental Automotive Technologies GmbH, Hannover (DE)

(21) Appl. No.: 17/937,628

(22) Filed: Oct. 3, 2022

(30) Foreign Application Priority Data
Oct. 1, 2021 (DE) 10 2021 211 054.1

(51) Int. Cl. G06N 5/02

(52) U.S. Cl. CPC G06N 5/022; B60W 60/001

(57) ABSTRACT

The present disclosure relates to a method for building a training dataset on a server, including the steps of: analyzing meta information of the training dataset for a requirement to extend the training dataset; and based on the requirement, sending a data capturing task to a data capturing device, in particular a vehicle.

### CROSS-REFERENCE TO RELATED APPLICATIONS

The present application claims the benefit and/or priority of German Patent Application No. 10 2021 211 054.1 filed on Oct. 1, 2021, the content of which is incorporated by reference herein.

### TECHNICAL FIELD

The present invention relates to methods and devices for building a balanced training dataset. The invention also relates to computer-readable storage media.

### BACKGROUND

It is known that sufficiently large training datasets are of central importance for modern machine learning algorithms. In particular, in the context of autonomous driving, huge amounts of training data are required so that autonomous vehicles can also be trained and tested for unusual difficult situations.

Various methods for capturing sensor data with a fleet of vehicles equipped with sensors and for storing the sensor data centrally are known in the prior art.

However, it has emerged that the training datasets thus obtained are not yet sufficient to reliably train an algorithm for autonomous driving. In addition, it is difficult to handle the vast amounts of data accruing, which have to be transferred and stored.

### SUMMARY

It is an object of the present disclosure to provide improved methods and devices for building a training dataset. This object is addressed by the subject-matter of the independent claims. Embodiments and further developments are to be inferred from the dependent claims, the description and the figures.

A first aspect of the present disclosure relates to a method for building a training dataset on a server, comprising the steps of:
analyzing meta information of the training dataset for a requirement to extend the training dataset, and
based on the requirement, sending a data capturing task to a data capturing device, in particular a vehicle.

The present disclosure is based on the realization that it is not only a matter of having as many datapoints as possible in the training dataset, but that the datapoints must also cover different scenarios in order to be useful for training an algorithm.

It goes without saying that, here and below, the term “datapoint” does not necessarily have to refer to data at a point in time (e.g., a measured value at a particular point in time), but can also comprise an amount of information which has been recorded at a plurality of points in time. For example, a datapoint could comprise a video which has been recorded of the surroundings of the vehicle during a particular period of time. A datapoint can also be referred to as an example or a sample.

In this case, the term “training dataset” generally refers to a dataset which can be conveniently used to train and/or test a machine learning method.

After sending the data capturing task to the data capturing device, the captured data can be obtained and added to the training dataset.

The fact that the method of the first aspect first of all determines a requirement to extend the training dataset means that the training dataset can be extended in a targeted manner. Consequently, this avoids the possibility of the training dataset being inflated by superfluous datapoints (e.g., datapoints in an area where there are already very many datapoints) and, consequently, enormous storage space and resources being needed, without contributing to better training.

It is provided that the method further comprises an initial step of obtaining an item of meta information of a new datapoint from the data capturing device, wherein the data capturing task comprises an instruction to the data capturing device to send sensor data of the new datapoint to the server.

In particular, the sensor data can be produced using LIDAR, RGBD, stereo cameras or a fusion of these sensors.

It is provided that the process of analyzing for a requirement to extend the training dataset comprises determining a distance of the meta information of the new datapoint from meta information of datapoints of the training dataset, and the requirement to extend the training dataset is determined as a function of the distance.

In particular, it can be provided that an extension requirement is only seen if the meta information of the new datapoint has a greater gap from existing datapoints of meta information than a particular predefined gap.

It is provided that the data capturing device is a vehicle of a vehicle fleet and the datapoint comprises sensor data from an interior and/or exterior of the vehicle.

It is provided that the meta information includes vector representations of sensor data.

The vector representation can in particular constitute a semantic representation. Consequently, e.g., particular directions in the vector space can correspond to particular semantic concepts.

The advantage of this is that new data strategies can be produced from the meta information in vector representation (e.g., by cluster analysis) and these can then be semantically evaluated so that the data collection strategy can be executed and parameterized in a targeted manner. In addition, instructions which can be understood by a human driver could be deduced directly in some embodiments.

It can further be provided that the process of analyzing the training dataset comprises performing a cluster analysis on the training dataset in order to determine a plurality of clusters of the training dataset.

It can further be provided that the method further comprises determining a compensation strategy for the plurality of clusters, wherein the process of determining the compensation strategy comprises determining clusters which comprise too low a number of datapoints.

Consequently, the method can contribute to a compensation of the cluster sizes and, all in all, build a compensated training dataset and, in particular, avoid a bias.

It can further be provided that a cluster comprises too low a number of datapoints, if the number of datapoints of this cluster is lower than a predetermined proportion of the average number of datapoints of the plurality of the clusters.

A further aspect of the present disclosure relates to a server which is configured to execute a method as described above.

It goes without saying that the server does not have to be a single physical server, but the method can also be implemented in the cloud, i.e., distributed among a plurality of servers, possibly spatially separated from one another.

A further aspect of the present disclosure relates to a method for building a training dataset with a data capturing device, wherein the method is executed by the data capturing device and comprises the steps of:
capturing sensor data,
determining an item of meta information regarding the sensor data,
sending the meta information to a server,
receiving a transfer instruction, and
sending the sensor data to the server based on the transfer instruction.

It is provided that the process of determining the meta information comprises imaging the sensor data in a high-dimensional vector space, in particular an at least 10-dimensional vector space.

A further aspect of the invention relates to a data capturing device, in particular a vehicle of a vehicle fleet, for use with a server as described above, wherein the data capturing device is configured to execute one of the methods described above.

It is provided that the data capturing device further comprises an output device for outputting an instruction to a driver of the vehicle, wherein the output device in particular includes an audio output unit for outputting a voice output, a display and/or a device for representing a destination on a map and/or a device for representing a navigation direction.

Consequently, it is possible to output instructions to a human driver so that he can direct the vehicle in such a way that important datapoints are collected in a targeted manner. For example, one of the servers could have come to the conclusion that a particular driving situation, for example, a particular confusing intersection in the training dataset is only supplied with datapoints on sunny days during the day. In this case, it might make sense to collect datapoints of this intersection at night as well.

In other embodiments, it can be provided that an automated vehicle performs the data capturing. For this purpose, it can in particular be provided that the data capturing device further comprises an instruction outputting device which outputs instructions to an autonomous control device of the vehicle.

For example, vehicles which are not being utilized can be used for this purpose or other routes can be selected in the case of “robotaxis” or the routes can be automatically adjusted during return journeys without passengers. To this end, it can be provided that the vehicle can access an annotated map. If, for example, training points are missing in a driving scenario which has a one-way street, the annotated map could be used to recognize the location of such one-way streets, on which required additional datapoints can be collected.

A further aspect of the present disclosure relates to a computer-readable storage medium which stores program code, wherein the program code comprises commands which, if they are executed by a processing unit, execute one of the aforementioned methods.

### BRIEF DESCRIPTION OF THE DRAWINGS

The appended drawings are intended to convey a further understanding of the embodiments of the present disclosure. The appended drawings illustrate embodiments and, in connection with the description, serve to explain concepts of the invention. Other embodiments and many of the indicated advantages are set out with respect to the drawings. The depicted elements of the drawings are not necessarily shown true to scale with respect to one another, wherein:

FIG. 1 shows a schematic representation of a vehicle system architecture;

FIG. 2 shows an exemplary schematic representation of a system from a server which is connected to multiple vehicles and a data memory;

FIG. 3 shows a flow chart of a method for building a training dataset, which is executed on a data capturing device;

FIG. 4 shows a flow chart of a method for building a training dataset, which is executed on a server;

FIGS. 5a-5c show an exemplary illustration of meta information in the form of word vectors;

FIG. 6 shows an exemplary illustration of meta information of datapoints in a dataset in the form of word vectors;

FIG. 7 shows a flow chart of a method for building a training dataset, which is executed on a server; and

FIG. 8 shows a flow chart of a method for building a training dataset, which is executed on a server.

### DETAILED DESCRIPTION

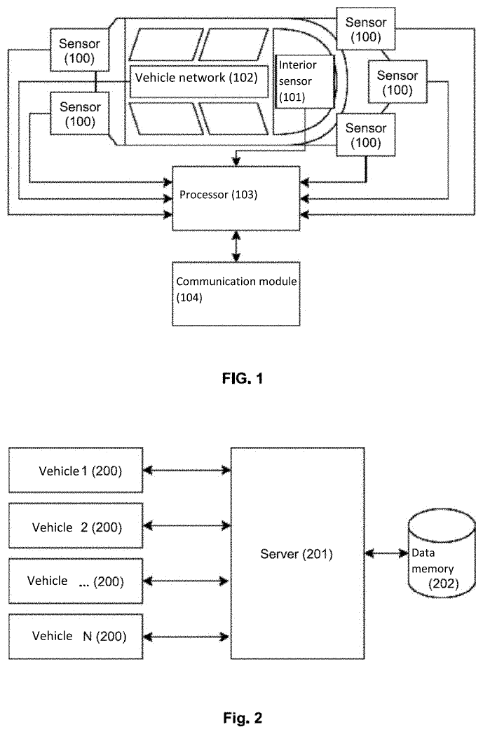

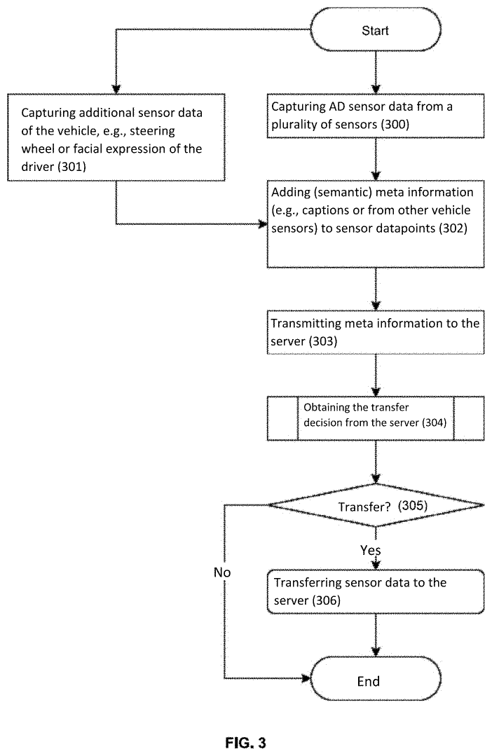

FIG. 1 shows an exemplary vehicle system architecture. It comprises a plurality of external sensors 100, e.g., camera, LIDAR or RADAR, which detect the external surroundings of the vehicle. Furthermore, one or more interior sensors 101 can be provided, which detect the cab of a vehicle. Apart from the specific sensors, the vehicle network 102, e.g., CAN bus, can also be used in order to collect additional information, e.g., steering angle. The sensors 100 and 101 and the vehicle network 102 are connected to a processor 103 which executes the routine depicted in FIG. 3. Furthermore, the processor is connected to a communication module 104 in order to communicate with a server 201 which is depicted in FIG. 2. As depicted therein, the server 201 is connected, e.g., by a wireless connection, to a plurality of vehicles which are additionally referred to as a vehicle fleet, and to a data memory 202.

Various problems can arise during data capturing in the prior art:
The known approaches require an enormous amount of data in order to collect all of the collected datapoints from a vehicle fleet,
No meta data compositionality is utilized and typically utilized uncertainty measures are only a very coarse indicator of the requirements of the training data,
There can be a large amount of redundant/repetitive data in uncertain regions of the feature space due to inadequate filtering techniques. This leads to problems during the data capturing and storage (and can therefore lead to a disequilibrium of the random samples),
As a consequence, the machine learning models trained with such data can be suboptimal and have a strong bias,
The compositionality of meta data, e.g., on the basis of automatically generated textual image descriptions (image captioning), is not yet utilized for the data collection and evaluation. Thresholds for the conspicuousness of meta data can be used in order to trigger the maintenance of machine learning models and components at regular intervals (e.g., orchestration of data capturing tasks, planning of annotation tasks, retraining for scenarios in which the data are no longer distributed), and
Only preconfigured data filtering techniques are available (with the exception of techniques which are based on uncertainty measures).

One or more of these problems can be solved, e.g., with the following embodiments.

First of all, it is described how the data capturing is realized by the vehicles interacting with the server. As mentioned, FIG. 3 shows the method which is executed on the processor 103 in order to collect sensor data.

The routine begins with the synchronous capturing of sensor data by the AD sensors (external sensors) 300 and the interior sensors 301. Furthermore, data are also captured from the vehicle network (step 301). The external sensors supply raw sensor data, e.g., images or point clouds, from cameras, LIDARs or RADARs. The internal sensors supply semantic descriptions of the cab, e.g., facial expressions of the driver, the activities of occupants or the driver's standby status. The vehicle network can be used in order to obtain information regarding the steering angle, the speed or the acceleration.

In the next step, the data of steps 300 and 301 are processed in step 302. As a result, the sensor raw data are processed by the external sensors in order to obtain meta information (e.g., through image captioning) which makes it possible to represent the datapoint in the semantic (word) vector space. As a result, a datapoint can be data from a single timestamp or a sequence of datapoints. A brief explanation of semantic (word) vector spaces will be provided below. Apart from the meta information of the external sensor data, the information from the indoor sensor and from the vehicle network can also be added to the datapoint. A datapoint can in particular comprise raw sensor data and the corresponding meta information.

In step 303, the meta information of datapoints is transferred to the server. As a result, a single datapoint or a batch of datapoints can be transferred.

Step 304 waits for a response from the server regarding the transferred meta information. The server decides whether the raw data should be sent to the server and incorporated into the data memory or whether the raw data should be discarded, e.g., since similar data are already available in the data memory. See the next paragraph as well.

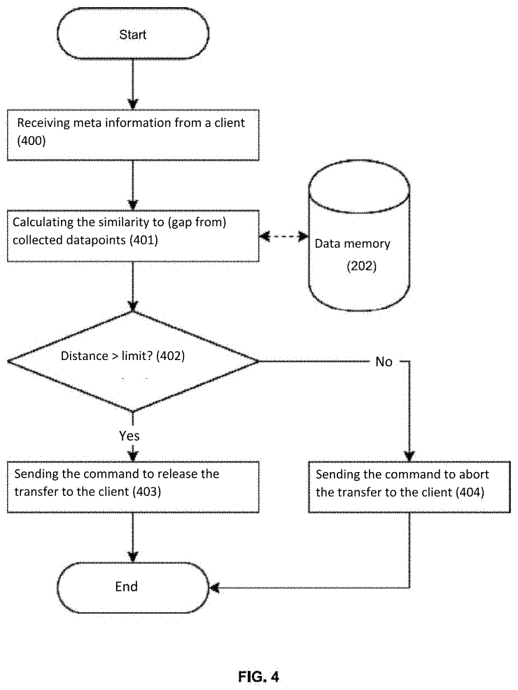

The next step 305 receives the response from the server and takes actions as a function of the reply. If the datapoint is to be retained, the sensor data are sent to the server in step 306. Otherwise, they are discarded. As mentioned, the server tests, based on the meta information, whether a datapoint should be incorporated into the data memory (or a training dataset stored in the data memory). FIG. 4 shows the method which is executed on the server in order to assess the meta information of a datapoint.

The routine begins with the receipt of meta information of a datapoint from a client (vehicle) (step 400).

Then, in step 401, a similarity between the meta information of the received datapoints and the datapoints which are already in the data memory is calculated and evaluated in a comparison in step 402.

If the distance is greater than a defined threshold (check in step 402), the server sends a command to release the transfer to the appropriate vehicle in step 403. The datapoint is then received by the vehicle and incorporated into the data memory.

Otherwise, the server sends a command to abort the transfer to the appropriate vehicle, in step 404, and the datapoint is discarded.

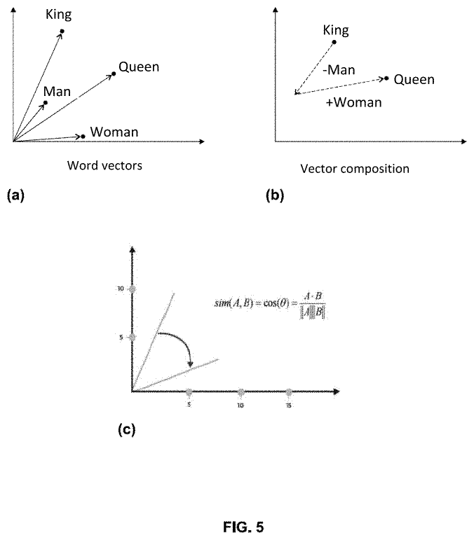

The following paragraph provides some insight regarding the representation of the meta information and the calculation of the similarity. FIG. 5 shows three diagrams. In 5(a) there is an exemplary two-dimensional vector space with 4-word vectors which can be treated as the meta information of the datapoints. If the vector space is well defined by, e.g., image captioning, it makes possible vector operations such as the composition shown in 5(b). In the example, it is possible to transform the concept of “king” into the concept of “queen” by subtracting “man” and adding “woman”. This property is helpful in order to approximate meta information regarding unseen datapoints in the vector space, which can be used in order to formulate data collection strategies. The following paragraphs describe how the collection strategies are deduced.

In order to calculate the similarity between two vectors (from meta information), cosine similarity can be used in a vector space, as shown in 5(c). This can be applied in step 401.

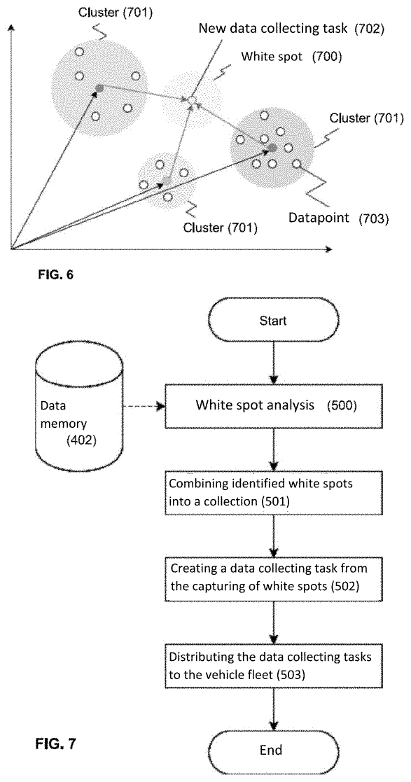

Based on the introduced vector space, FIG. 6 shows an exemplary vector space representation for the data memory. There are 3 clusters 701 with datapoints 703. The center of a cluster is highlighted. The intention behind a cluster is that each cluster has datapoints which belong together in terms of content. This is expressed, e.g., by the fact that the meta information of datapoints of a cluster is very similar. Based on this example, white spots (that is to say in which there are no datapoints) can be deduced by vector processes and cosine similarity. These white spots can be used in order to formulate data collecting tasks for the vehicle fleet. One example would be that the white spot can be achieved by adding the concept “night” to an existing cluster. This can then be used in order to instruct automated vehicles to specifically record datapoints during the night.

It can also be provided that particular directions in the vector space are marked as particularly relevant. For example, these directions can correspond to semantic concepts such as day/night, light/dark, a lot of/little traffic, etc. Here it could be known that it is particularly important that training points are available for different values of these directions.

In other embodiments, it can be provided that datapoints are weighted based on particular meta information. For example, a datapoint could have a higher weighting if it originates from a vehicle, the driver of which was vigilant when the datapoint was recorded and/or was generally known to be a reliable driver. This weighting can be taken into account when determining a requirement for an extension of the training dataset. For example, it could be more important to collect further datapoints for a particular region of the vector space if there are only datapoints from overtired or unreliable drivers in this region and it is, consequently, unclear whether the datapoints reflect sensible driver conduct. For example, if the requirement to extend the training dataset is determined, the weighting of the datapoints in the training dataset can be taken into account such that the necessary gap from an existing datapoint, so that no data capturing task is created, is proportional to the weighting of this existing datapoint.

Various factors can be taken into account during the weighting of the datapoint. In particular, the weighting of meta information can be dependent on sensor data from the interior of the vehicle. For example, the meta information can include a facial expression of the driver, the emotional state of the driver, commotion in the vehicle (deduced, for example, from the volume in the interior compared to the volume externally), driver fatigue, and/or additional factors.

The following two routines run on the server and deal with redistribution and white spot recognition of the data memory. White spot recognition is described first of all, as shown in FIG. 7.

The white spot analysis (500) uses the data memory 202 in order to extract white spots as described in the previous paragraph.

The white spots are then combined into a collection in which similar white spots belong together (step 501).

Next, in step 502, data collecting tasks are produced by extracting the semantic features (meta information) from the white spots.

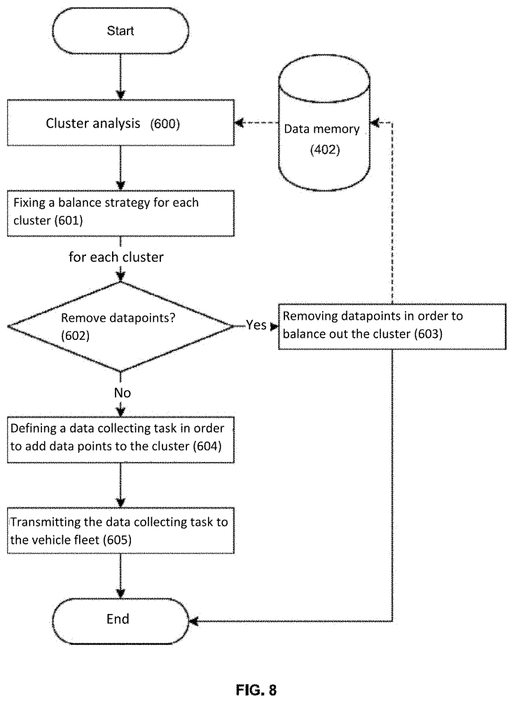

The redistribution of the data memory (which includes the training dataset) proceeds as follows (see FIG. 8).

The redistribution begins with the performance of a cluster analysis 600, which can be realized by cluster methods (e.g., mean shift) using the data memory 202.

A compensation strategy for each relevant cluster is then defined in step 601.

Based on the capacity of the data memory, the number of datapoints per cluster and the distance of the cluster from the other clusters is defined. It should be noted that no compensation has to be performed for some clusters as they have already been balanced out.

A check is subsequently carried out for each cluster as to whether the compensation strategy includes removing samples (step 602). If yes, samples are removed from the cluster, e.g., based on the weighting (step 603).

Otherwise, a data collecting task is defined in order to add more datapoints to the cluster (step 604).

As already indicated above, it can be provided in other embodiments that the cluster is simply left unchanged in many cases, that is to say new datapoints are neither added nor are existing datapoints removed.

Due to the white spot recognition and redistribution, the data memory can be extended, on the one hand, with required datapoints and kept compact by redistribution. This ensures that the data memory only contains valuable datapoints and does not exceed the storage restrictions.

The present disclosure can also be applied to other areas.

The data collection, annotation (i.e., description), sample mining and algorithm validation (e.g., camera technology) are an integral part of each machine learning pipeline. This extends the scope of this invention so that it can be applied to a plurality of scene detection problems, including but not limited to:
smart home monitoring applications,
high-precision sports monitoring,
monitoring the vehicle cab,
monitoring traffic and activity in smart cities,
monitoring quality in smart factories (e.g., industry 4.0),
other applications of the Internet of Things (IOT) including drones and smart sensors, and
high-precision agriculture and many robotics applications.

The production of temporal meta data (i.e., captions) could be used to describe a sequence of events while they unfold over time. Such events would correspond to a volumetric space (i.e., make it possible for a plurality of video frames to be encoded simultaneously).

Instead of individual captions, meta data of a paragraph can be used in order to create complex scenarios and recordings. In this case, the mining for recordings becomes more similar to document retrieval.

The method described herein could also be extended to RADAR or point clouds.

The advantages of some embodiments can comprise:
Reduction of the required extent of the database which includes recorded data from the vehicle fleet,
Increase in the variance of the collected data in order to increase the robustness of ML models for automated driving functions,
Facilitation of automated mechanisms for (re)training ML models for automated driving functions (e.g., pedestrian recognition),
Generation of specific data capturing tasks for fully automated vehicles through analysis of the database (in order to reduce distortions and make possible better coverage),
Lower costs associated with the storage since only recorded datapoints are incorporated into the data memories if they do not overlap with existing datapoints or are not too similar to the existing datapoints,
Lower costs associated with tampering since the data memory is kept as small as possible due to the re-compensation and the use of vector space operations, and
Targeted definition of data collecting tasks for a vehicle fleet in order to collect datapoints which will increase the diversity of the data memory.

### LIST OF REFERENCE NUMERALS

100 Sensor
101 Interior sensor
102 Vehicle network
103 Processor
104 Communication module
200 Vehicle 1 . . . N
201 Server
202 Data memory
300 Capturing of AD sensor data by a plurality of sensors
301 Capturing additional sensor data of the vehicle, e.g., steering angle or facial expression of the driver
302 Adding (semantic) meta information (e.g., captions or from other vehicle sensors) to sensor datapoints
303 Transmitting meta data to the server
304 Obtaining the transfer decision from the server
305 Checking for transfers
306 Transferring sensor data to the server
400 Receiving meta information from a client
401 Calculating the similarity to (gap from) collected datapoints
402 Checking whether distance>limit
403 Sending the command to release the transfer to the client
404 Sending the command to abort the transfer to the client
500 White spot analysis
501 Combining identified white spots into a collection
502 Creating a data collecting task from the capturing of white spots
503 Distributing the data collecting tasks to the vehicle fleet
600 Cluster analysis
601 Fixing a compensation strategy for each cluster
602 Remove datapoints?
603 Removing datapoints in order to balance out the clusters
604 Defining a data collecting task in order to add datapoints to the cluster
605 Transmitting the data collecting task to the vehicle fleet
700 White spot
701 Cluster
702 New data collecting task

1. A method for building a training dataset on a server, comprising:
analyzing meta information of the training dataset for a requirement to extend the training dataset, and
based on the requirement, sending a data capturing task to a data capturing device.

2. The method according to claim 1, wherein the method further comprises an initially obtaining an item of meta information of a new datapoint from the data capturing device, and wherein the data capturing task comprises an instruction to the data capturing device to send sensor data of the new datapoint to the server.

3. The method according to claim 2, wherein the analyzing for a requirement to extend the training dataset comprises determining a distance of the meta information of the new datapoint from meta information of datapoints of the training dataset, and
the requirement to extend the training dataset is determined as a function of the distance.

4. The method according to claim 1, wherein the data capturing device is a vehicle of a vehicle fleet and wherein the datapoint comprises sensor data from an interior and/or exterior of the vehicle.

5. The method according to claim 1, wherein the meta information includes vector representations of sensor data, wherein directions in a vector space of the vector representations correspond to semantic concepts.

6. The method according to claim 1, analyzing the training dataset comprises performing a cluster analysis on the training dataset in order to determine a plurality of clusters of the training dataset.

7. The method according claim 6, wherein the method further comprises determining a compensation strategy for the plurality of clusters, wherein determining the compensation strategy comprises determining clusters which comprise too low a number of datapoints.

8. The method according to claim 7, wherein it is determined that a cluster comprises too low a number of datapoints if the number of datapoints of the cluster is lower than a predetermined proportion of an average number of datapoints of the plurality of the clusters.

9. A server, configured to execute a method according to claim 1.

10. A method for building a training dataset with a data capturing device, wherein the method is executed by the data capturing device and comprises:
capturing sensor data,
determining meta information regarding the sensor data,
sending the meta information to a server,
receiving a transfer instruction, and
sending the sensor data to the server based on the transfer instruction.

11. The method according to claim 10, wherein determining the meta information comprises imaging the sensor data in a high-dimensional vector space.

12. A data capturing device for use with a server, wherein the data capturing device is configured to execute the method according to claim 10.

13. The data capturing device according to claim 12, wherein the data capturing device comprises a vehicle of a vehicle fleet, and the data capturing device further comprising an output device for outputting an instruction to a driver of the vehicle.

14. The data capturing device according to claim 12, further comprising an instruction outputting device which outputs instructions to an autonomous control device of the vehicle.

15. A computer-readable storage medium which stores program code, wherein the program code comprises commands which, if the commands are executed by a processing unit, execute the method according to claim 1.

16. The data capturing device according to claim 13, wherein the output device includes an audio output unit for outputting a voice output, a display and/or a device for representing a destination on a map and/or a device for representing a navigation direction.

17. The data capturing device according to claim 12, wherein the data capturing device comprises a vehicle of a vehicle fleet.

18. The method according to claim 11, wherein the high-dimensional vector space is at least a ten dimensional vector space.

19. The method according to claim 1, wherein the data capturing device comprises a vehicle.
